(19) United States
(12) Patent Application Publication
(10) Pub. No.: US 2015/0058007 A1
(43) Pub. Date: Feb. 26, 2015

(54) METHOD FOR MODIFYING TEXT DATA CORRESPONDING TO VOICE DATA AND ELECTRONIC DEVICE FOR THE SAME

(71) Applicant: Samsung Electronics Co. Ltd., Gyeonggi-do (KR)

(72) Inventors: Tai-Hyung KIM, Gyeongsangbuk-do (KR); Joo-Hyun MOON, Daegu (KR)

(21) Appl. No.: 14/469,396

(22) Filed: Aug. 26, 2014

(30) Foreign Application Priority Data
Aug. 26, 2013 (KR) 10-2013-0101343

(51) Int. Cl. G10L 15/26

(52) U.S. Cl. CPC G10L 15/26
USPC 704/235

(57) ABSTRACT

A method of modifying a voice to a text includes reproducing voice data included in a voice file, displaying text data included in the voice file; determining whether a user input for editing the text data is input, and editing the text data in response to the user input, if the user input for editing the text data is input.

### PRIORITY

This application claims priority under 35 U.S.C. §119(a) to Korean Application Serial No. 10-2013-0101343, which was filed in the Korean Intellectual Property Office on Aug. 26, 2013, the entire content of which is incorporated herein by reference.

### BACKGROUND

1. Field of the Invention

The present invention generally relates to a method for modifying text data corresponding to voice data and an electronic device for the same.

2. Description of the Related Art

The use of electronic apparatuses is increasing among people who need prompt information transmission. Accordingly, the electronic apparatus is used in various ways for not only simple telecommunication but also scheduling, image capturing by an embedded camera, watching a broadcast, playing a game, and a short distance communication. As one of the functions of the electronic apparatus that can realize various functions as described above, there is a technique of recording a voice and modifying the recorded voice into a character (text) by voice recognition.

An existing voice recognition technique of converting a voice to a text can easily create errors due to various reasons, and therefore accuracy of the modified text is low. Further, it is not easy to correct a portion of the modified text where the error occurs.

### SUMMARY

The present invention has been made to address the above problems and disadvantages, and to provide at least the advantages described below. Accordingly, an aspect of the present invention is to provide a method of modifying text data corresponding to voice data so as to enhance accuracy of the text data by correcting an error of the text generated while converting a voice into a text or after converting a voice into a text, and an electronic apparatus for the same.

In accordance with another aspect of the present invention, a method of modifying text data corresponding to voice data includes reproducing voice data included in a voice file; displaying text data included in the voice file; determining whether a user input for editing the text data is input; and editing the text data in response to the user input, if the user input for editing the text data is input.

In accordance with another aspect of the present invention, a method of generating text data corresponding to voice data includes generating voice data by receiving a voice from a user; generating text data synchronized with the voice data; and generating a voice file by combining the voice data and the text data.

In accordance with another aspect of the present invention, an electronic apparatus for modifying text data corresponding to voice data includes a controller configured to control the screen to reproduce the voice data and display the text data, determine whether a user input for editing the text data is input, and edit the text data in response to the user input if the user input for editing the text data is input.

In accordance with another aspect of the present invention, an electronic apparatus for generating text data corresponding to voice data includes a controller configured to generate voice data upon receiving a voice from a user, generate text data synchronized with the voice data, and generate a voice file by combining the voice data and the text data; and a screen configured to display the text data in real time.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a configuration of an electronic apparatus according to an embodiment of the present invention;

FIG. 2 is a flow chart illustrating a method in which an electronic apparatus illustrated in FIG. 1 converts voice data into text data;

FIG. 3 is a flow chart illustrating another method in which the electronic apparatus illustrated in FIG. 1 converts voice data into text data;

FIG. 4 is a flowchart illustrating still another method in which the electronic apparatus illustrated in FIG. 1 converts voice data into text data;

FIG. 5 is a diagram illustrating an example in which the voice data of the electronic apparatus illustrated in FIG. 1 is converted into the text data;

FIG. 6 is a diagram illustrating another example in which voice data of the electronic apparatus illustrated in FIG. 1 is converted into text data;

FIG. 7 is a diagram illustrating an example in which voice data stored in the electronic apparatus illustrated in FIG. 1 is presented in a list;

FIG. 8 is a diagram illustrating an example of adding a bookmark to text data synchronized with voice data of the electronic apparatus illustrated in FIG. 1; and

FIGS. 9A and 9B are diagrams illustrating an example of extracting a part of voice data or text data of the electronic apparatus illustrated in FIG. 1.

### DETAILED DESCRIPTION OF EMBODIMENTS OF THE PRESENT INVENTION

Hereinafter, various embodiments of the present invention will be described with reference to the accompanying drawings. Various specific definitions found in the following description are provided only to help in a general understanding of the present invention, and will be apparent to those skilled in the art that the present invention can be implemented without such definitions.

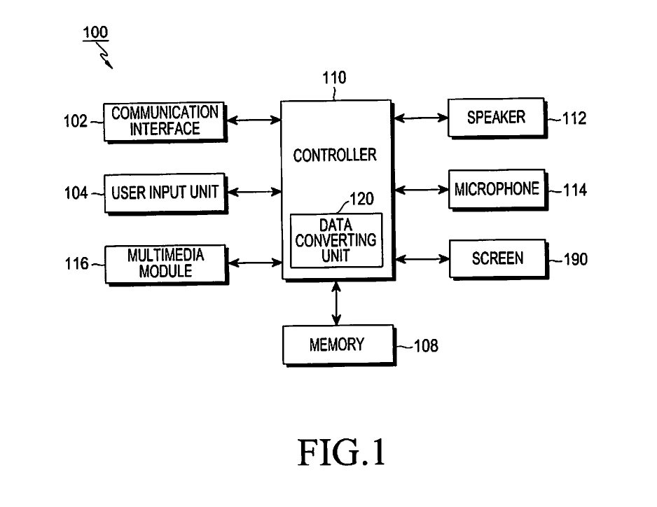

FIG. 1 is a block diagram illustrating a configuration of an electronic apparatus according to an embodiment of the present invention.

With reference to FIG. 1, an electronic apparatus 100 includes a screen 190, a controller 110, a speaker 112, and a microphone 114, and at least one of a communication interface 102, a user input unit 104, a memory 108, and a multimedia module 116.

The communication interface 102 performs a wired or wireless communication of the electronic apparatus 100. The communication interface 102 according to an embodiment of the present invention transmits voice data, text data, or a voice file including voice data and text data to another terminal, and receives voice data, text data, or a voice file including voice data and text data from another terminal.

The communication interface 102 can transmit the voice data to a text recognizing server, or can receive the text data synchronized with the voice data from the text recognizing server. The communication interface 102 can also receive a voice file in which the voice data and the text data are combined, from the text recognizing server.

The user input unit 104 receives a user input from the user. Further, the user input unit 104 can receive a user input for receiving a voice or a voice file from the outside including another terminal.

The user input unit 104 can receive a user input for displaying the text data synchronized with the voice data, on the screen 190. Further, the user input unit 104 can receive a user input for editing at least a part of the text data. The user input unit 104 can receive a user input for extracting at least a part of the voice data, and can receive a user input for extracting at least a part of the text data. The user input unit 104 can also receive a user input for performing a function of searching the text data synchronized with the voice data. For example, when the text data includes “Her mother lifted the little girl's too-thin arm and slipped the bunny underneath it, willing herself to believe that her daughter could feel the touch of synthetic softness.”, the user can input a user input for searching “bunny” in the text data to the electronic apparatus 100.

The screen 190 displays the data stored in the electronic apparatus 100. The screen 190 displays the text data into which the voice data is converted. Further, the screen 190 can display an execution screen for displaying the voice data.

Further, the screen 190 is embodied to include the user input unit 104 so that a user input can be received from the user. The screen 190 receives a user input for reproducing the voice data, a user input for setting an error area, an extraction area, a bookmark area, and a search area, and the like.

The screen 190 is embodied to be a touch screen so that the user can receive a user input (touch input) generated by contacting a part of the body (for example, a finger) with the screen 190 from the user. Further, the screen 190 can provide a user interface corresponding to various services (for example, a communication, data transmission, broadcasting, or photographing) to the user. The screen 190 transmits an analog signal (touch input) corresponding to at least one touch input to the user interface, to the controller 110, to cause the controller 110 to perform an operation corresponding to the touch input. The screen 190 receives at least one touch by the body of the user (for example, a finger) or a touchable input unit (for example, a stylus pen).

Further, the screen 190 may receive successive movements of one touch among the at least one touch. The screen 190 transmits an analog signal corresponding to a continuous movement of an input touch to the controller 110. The touch is not limited to a touch by the body of the user or the touchable input unit with the screen 190, and may include non-contact hovering (a detectable distance between the body of the user or the touchable input unit with the screen 190 is less than or equal to 1 mm). A distance or interval within which the user input means is recognized in the touch screen 190 may be modified according to a capacity or structure of the apparatus 100. The controller 110 according to the present embodiment controls the screen 190 so that various contents displayed on the screen 190 or display of the contents can be controlled.

As described above, the controller 110 controls the electronic apparatus 100 so that an operation corresponding to a touch input detected through the screen 190, that is, corresponding to the user input is performed. If a touch input for touching at least one point is input through the screen 190, the controller 110 controls the electronic apparatus 100 so that an operation corresponding to the touch input is performed.

The touch screen 190 may be implemented in, for example, a resistive type, a capacitive type, an infrared type, or an acoustic wave type.

Various data for controlling operations of the electronic apparatus 100 are stored in the memory 108. The voice data, the text data, and the voice file generated by a data converting unit 120 of the controller 110 are stored in the memory 108 according to the present embodiment.

The controller 110 controls various operations of the electronic apparatus 100. The controller 110 controls the microphone 114 so that a voice is input from the user. The controller 110 controls the speaker 112 or the multimedia module 116 so that the voice data is output.

The controller 110 includes the data converting unit 120 for converting a voice of the user input through the microphone 114 into the voice data. The data converting unit 120 generates the voice data by using the voice input through the microphone 114 and generates the text data synchronized with the voice data. Further, the data converting unit 120 generates the voice file by combining the voice data and the text data.

The data converting unit 120 of the controller 110 converts the voice of the user which is input through the microphone 114 into the voice data in real time. Further, the data converting unit 120 converts the text data synchronized with the voice data in real time by using the voice data converted in real time and generates the voice file by combining the voice data and the text data.

The controller 110 controls the communication interface 102 so that the voice data generated by the data converting unit 120 is transmitted to a text recognizing server in real time. The controller 110 performs control so that the communication interface 102 transmits the voice data to the text recognizing server in real time, and receives the text data synchronized with the voice data from the text recognizing server in real time.

Further, the controller 110 controls the screen 190 so that an execution screen indicating that a voice of the user is recording, an execution screen indicating the text data synchronized with the voice data, an execution screen for editing the text data, an execution screen for extracting the text data or the voice data from a voice file or extracting a part of the voice file, an execution screen for inserting a bookmark to the voice file or the text data, an execution screen for searching at least one word or phrase included in the text data, and the like, are displayed.

If a user input for editing the text data through the user input unit 104 or the screen 190 is received, the controller 110 can determine an error area in response to the user input. According to the present embodiment, the error area indicates an area in which a character to be edited is included. Further, such an error word indicates at least one character desired to be edited by the user, and can be differentiated by word spacing according to the embodiment. For example, assuming that “your sun” is determined to be an error area by the user, the controller 110 provides the user with an editing window for correcting the text “your sun” at once. Further, when the controller 110 determines “sun” as an error word out of the text “your sun”, the controller 110 provides the user with the words of which a similarity value with the text “sun” is greater than or equal to a reference value pre-stored in the memory 108. For example, the controller 110 can provide the user with the texts “son”, “sun”, “soon”, “song”, and the like as words with similarity values with “sun” greater than or equal to the reference value. The user can correct the text “your sun” as “your son” by inputting a user input for selecting at least one of the aforementioned words to the electronic apparatus 100.

In the present embodiment, it is described that the data converting unit 120 in the electronic apparatus 100 generates the voice data and the text data, but the text data or the voice file may be generated in a device outside the electronic apparatus 100, for example, a text recognizing server according to another embodiment. The electronic apparatus 100 generates the voice data by using a voice input from the user and transmits the voice data to the text recognizing server. The text recognizing server generates the text data synchronized with the voice data by using the voice data. The text recognizing server can transmit the text data to the electronic apparatus 100 or transmit the text data or a voice file combined with the voice data to the electronic apparatus 100.

According to the embodiment, when the text data is generated, the controller 110 displays corresponding words in different colors according to the accuracy of the words included in the text data. For example, it is assumed that text data “I do not know” is generated. In addition, it is assumed that among the text data, the accuracy of “I” is 100%, the accuracy of “do” and “not” is 75%, and the accuracy “know” is “50%”. The controller 110 can display the text data “I” in black, the text data “do” and “not” in blue, and the text data “know” in red so as to inform the user of the accuracy of the text data. At this point, the controller 110 determines colors of the words included in the text data according to an accuracy standard stored in the memory 108 in advance.

According to the embodiment, when the text data is displayed by the screen 190, the controller 110 controls the screen 190 so that a part identical to the voice data is displayed to be differentiated from a part which is not identical to the voice data. For example, it is assumed that there are text data “I am fine. Thank you.” and voice data corresponding to the text data. If a voice corresponding to “I am fine” is reproduced in the voice data, the controller 110 according to the present embodiment controls the electronic apparatus 100 so that the text “I am fine” is displayed to be differentiated from the text “Thank you” For example, if the text “I am fine. Thank you” is displayed in black, the controller 110 controls the screen 190 so that the text “I am fine” that is being reproduced is displayed in red to be differentiated from the text “Thank you” which is not reproduced. The controller 110 according to the present embodiment can continuously perform an operation of matching voice data and text data as described above during the reproduction of the voice data.

The speaker 112 outputs voice data reproduced by the multimedia module 116 under the control of the controller 110 to the outside.

The microphone 114 receives an input of a voice from the user or from the outside including another terminal under the control of the controller 110.

The multimedia module 116 reproduces various kinds of media data (for example, a still image or a moving image) stored in the memory 108. The multimedia module 116 according to the present embodiment can reproduce the voice data stored in the memory 108.

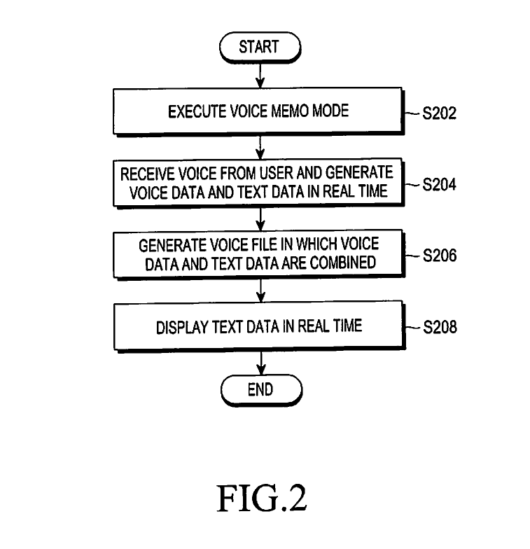

FIG. 2 is a flow chart illustrating a method in which an electronic apparatus illustrated in FIG. 1 converts voice data into text data.

With reference to FIG. 2, the controller 110 performs a voice memo mode in step S202. The voice memo mode according to the present embodiment indicates an operation mode of generating voice data by recording a voice of the user input through the microphone 114. Further, the electronic apparatus 100 according to the present embodiment generates the voice data by receiving and recording the voice from the user in real time in the voice memo mode. Further, the electronic apparatus 100 can generate text data synchronized with the voice data.

When the voice memo mode is executed, the electronic apparatus 100 receives the voice from the user and generates the voice data and the text data in real time in step S204. In step S204, the controller 110 receives the voice of the user by controlling the microphone 114. The data converting unit 120 converts the voice into the voice data. Further, the data converting unit 120 can generate text data corresponding to the voice data by analyzing the voice data. For example, it is assumed that the user performs recording by inputting a voice “How did you find me?” by the microphone 114. The data converting unit 120 first converts the voice input as “How did you find me?” into the voice data. Further, the data converting unit 120 can extract the words “how”, “did”, “you”, “find”, and “me” from the voice data by analyzing the voice data. Accordingly, the data converting unit 120 generates the text “How did you find me?” in an order of being received by the microphone 114 as the text data corresponding to the voice data. A voice file is generated by inserting the text data described above to the voice data. According to the present embodiment, the data converting unit 120 generates the voice file by synchronizing the voice data and the text data. That is, the text data can be inserted to a voice part corresponding to the text included in the text data. For example, the data converting unit 120 combines the text data and the voice data so that the text data “How did you find me?” is displayed on the screen 190 while the voice data “How did you find me?” is reproduced.

As described above, the data converting unit 120 generates the voice file in which the voice data and the text data are combined in step S206. Further, the screen 190 displays the text data in real time in step S208.

After step S208, according to another embodiment, the controller 110 can determine whether the reception of the voice from the user has ended or not. According to this embodiment, the controller 110 determines whether the reception of the voice from the user, that is, the recording of the voice, has ended, after a certain amount of time stored in the memory 108 has expired (for example, 10 seconds). According to another embodiment, the controller 110 may determine that the reception of the voice from the user has ended if the voice is not input through the microphone 114 for more than the time (for example, 5 seconds) stored in the memory 108 in advance. Further, if the reception of the voice from the user has ended, the controller 110 can control the electronic apparatus 100 to end the generation of the voice data and the text data.

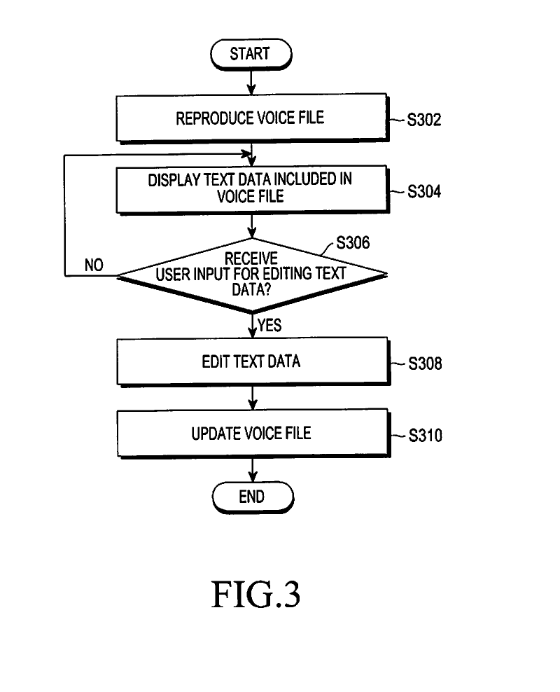

FIG. 3 is a flow chart illustrating another method in which the electronic apparatus illustrated in FIG. 1 converts the voice data into the text data.

With reference to FIG. 3, the multimedia module 116 reproduces a voice file in step S302. If the voice file is reproduced, the controller 110 according to the present embodiment controls the electronic apparatus 100 so that the text data included in the voice file is automatically displayed on the screen 190. Accordingly, the electronic apparatus 100 displays the text data included in the voice file on the screen 190 in step S304. In the present embodiment, it is assumed that the text data and the voice data are synchronized. Accordingly, in step S304, the screen 190 displays the text data synchronized with the voice data under the control of the controller 110.

If the voice file is reproduced in step S302 according to another embodiment, the controller 110 determines whether the user input for displaying the text data included in the voice file is received or not. According to the embodiment, the controller 110 can receive a user input for displaying the text data through the user input unit 104 or the screen 190. For example, the user may input the user input for displaying the text data to the electronic apparatus 100 by performing a touch input of touching any one point of the execution screen displayed on the screen 190 during the voice file is reproduced.

Thereafter, the controller 110 determines whether the user input for editing the text data displayed on the screen 190 is received or not in step S306.

As a result of the determination in step S306, if the user input for editing the text data is not received, the process returns to step S304 and the text data included in the voice file is continuously displayed on the screen 190.

After the determination in step S306, if the user input for editing the text data is received, the controller 110 edits the corresponding text data in step S308. In step S308, the user inputs the user input for editing the text data to the electronic apparatus 100 by inputting an input for selecting a part to be edited in the text data displayed on the screen 190 to the electronic apparatus 100. For example, the user can input the user input for editing the text “can't” to the electronic apparatus 100 by touching a part corresponding to the text “can't” in the text data “I can't save her” displayed on the screen 190.

According to the embodiment, the user input for editing the text data may be, for example, the touch input in which the user touches a point where the word desired by the user to be edited is displayed, in the execution screen on which the text data is displayed. If the point where the word desired by the user to be edited is touched, on the execution screen on which the text data is displayed, as described above, the controller 110 according to the present embodiment sets the word or the text including the point as an “error area”. According to the embodiment, the user can input the user input for setting the error area by horizontally or vertically dragging the point in a state in which the point in the screen 190 is selected. At this point, the error area may be the entire area dragged by the user.

If the text data is edited, the controller 110 updates the voice file by using the edited text data in step S310. In step S310, the controller 110 updates the voice file by reflecting the edited text data to the voice file. Further, although it is not illustrated in FIG. 3, the controller 110 controls the electronic apparatus 100 so that the text data is continuously displayed. According to the embodiment, the controller 110 controls the screen 190 so that the text data edited in step S310 is displayed. In addition, the controller 110 can control the electronic apparatus 100 so that new text data generated after step S310 is also displayed on the screen 190.

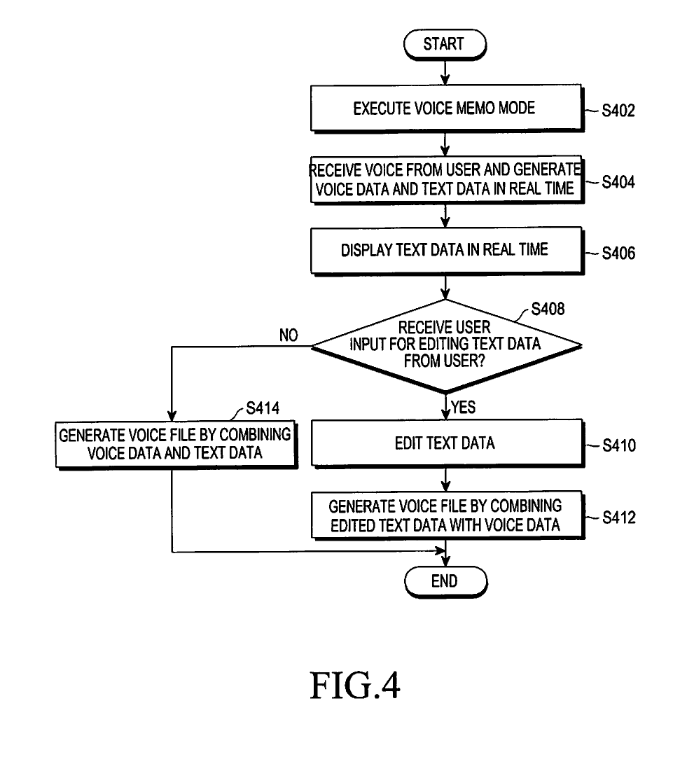

FIG. 4 is a flowchart illustrating another method in which the electronic apparatus illustrated in FIG. 1 converts the voice data into the text data.

With reference to FIG. 4, the controller 110 executes a voice memo mode in step S402. According to the present embodiment, the voice memo mode indicates an operation mode for generating the voice data by recording the voice of the user input through the microphone 114. Further, the electronic apparatus 100 according to the present embodiment generates text data corresponding to the voice data by using the voice data in the voice memo mode.

If the voice memo mode is executed, the electronic apparatus 100 receives the voice from the user and generates the voice data and the text data in real time in step S404. In step S404, the controller 110 receives the voice from the user by controlling the microphone 114. The data converting unit 120 converts the voice into the voice data. Further, the data converting unit 120 generates the text data corresponding to the voice data by analyzing the voice data. According to another embodiment, the data converting unit 120 of the electronic apparatus 100 can generate the voice data only. If the voice data is generated, the controller 110 transmits the voice data to the text recognizing server by controlling the communication interface 102. The communication interface 102 receives the text data generated in real time through the text recognizing server. At this point, the text recognizing server converts the voice data received from the electronic apparatus 100 into text data, and transmits the text data to the electronic apparatus 100 in real time.

The controller 110 displays the text data in real time in step S406. Further, the controller 110 determines whether the user input for editing the text data is received from the user or not in step S408.

As a result of the determination in step S408, if the user input for editing the text data is not received, the controller 110 generates a voice file by combining the voice data and the text data in step S414. At this point, the data converting unit 120 generates the voice file in real time by combining the voice data and the text data, which are generated in real time.

As a result of the determination in step S408, if a user input for editing the text data is received, the controller 110 edits the corresponding text data in step S410. According to the embodiment, the user can input the user input for editing the text data to the electronic apparatus 100 by inputting the input for selecting a to-be-edited part of the text data displayed on the screen 190 to the electronic apparatus 100 in step S406.

If the text data is edited, the data converting unit 120 of the controller 110 generates the voice file by combining the edited text data and the voice data in step S412. In step S412, the controller 110 can update the voice file by reflecting the edited text data to the voice file.

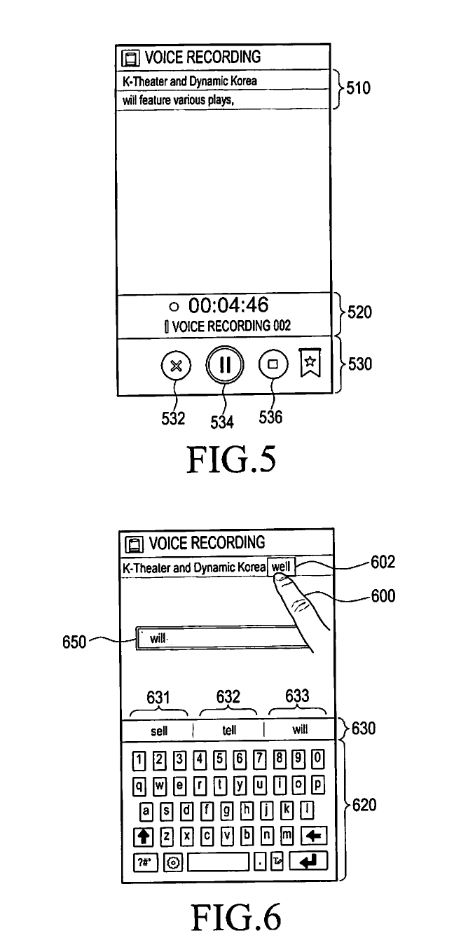

FIG. 5 is a diagram illustrating an example in which the voice data of the electronic apparatus illustrated in FIG. 1 is converted into the text data. FIG. 5 is an execution screen for receiving the voice from the user when the electronic apparatus 100 executes the voice memo mode.

In FIG. 5, it is assumed that the user inputs “K-Theater and Dynamic Korea will feature various plays”, as a voice to the electronic apparatus 100 by using the microphone 114. The data converting unit 120 according to the present embodiment generates the voice data and the text data by using the voice of the user. The screen 190 displays a text data 510 generated by the data converting unit 120 as illustrated in FIG. 5.

Further, the controller 110 provides the execution screen including a recording time notification 520 and a recording menu 530 to the user as illustrated in FIG. 5. The recording time notification 520 includes a recording time and a title. The recording time of the user in FIG. 5 is presented to be “00:04:46”, and the title of the recorded voice is “voice recording 002”. The user can start, pause, end, or cancel the recording of the voice by inputting the user input for selecting at least one item in the recording menu 530 to the electronic apparatus 100. In FIG. 5, a first button 532 is for cancelling the recording, a second button 534 is for pausing/starting the recording, and a third button 536 is for ending the recording. In FIG. 5, the user starts, pauses, ends, or cancels the recording of the voice by selecting any one of the first to third buttons 532, 534, and 536.

According to another embodiment, the controller 110 controls the communication interface 102 so that the voice data generated by the data converting unit 120 is transmitted to the text recognizing server, and the text data 510 generated by using the voice data is received. The transmission of the voice data and the reception of the text data 510 can be performed together with the voice recording of the user in real time. The controller 110 controls the screen 190 so that the text data 510 is received from the text recognizing server in real time, and the text data 510 is displayed in real time.

FIG. 6 is a diagram illustrating another example in which the voice data of the electronic apparatus illustrated in FIG. 1 is converted into the text data. FIG. 6 is an execution screen in which the text data displayed in real time is edited by the user.

With reference to FIG. 6, the screen 190 displays a text data 610 of “K-Theater and Dynamic Korea well”. A user 600 inputs the user input for editing the text data 610 to the electronic apparatus 100 by touching a to-be-edited part (hereinafter, an error area) 602 of the execution screen displayed on the screen 190.

If the user input for editing the text data 610 is input by the user, the controller 110 controls the screen 190 so that the editing window 610 is displayed on the execution screen as illustrated in FIG. 6. The controller 110 receives the user input for editing the text data 610, especially the error area 602 therein, through the editing window 610 from the user.

This operation is performed in order to edit the text data 610, and the controller 110 can receive an input of a text from the user by displaying a keypad 620 on the screen 190. Further, the controller 110 can extract and display words of which similarity values with the error words are greater than or equal the reference value, included in the part desired by the user to be modified, that is, in the error area 602, which includes the similar words 630 (631, 632, and 633) from the memory 108. The controller 110 can receive the user input for selecting at least one of the similar words 631, 632, and 633 among the similar words 630 through the screen 190 or the user input unit 104. As described above, if one of the similar words 631, 632, and 633 is selected, the controller 110 modifies the error word into the similar word 630 selected by the user.

For example, a part of the execution screen of FIG. 6 which is desired by the user to be edited, that is, the error area 602, is the word “well”, and a word 631 of “sell”, a word 632 of “tell”, and a word 633 of “will” are displayed as the similar word 630 with “well”. If the user 600 selects the word 633 of “will” among the similar words 630, the controller 110 can edit the text data 610 by modifying or replacing the word “well” with the word “will”

According to another embodiment, the controller 110 of the electronic apparatus 100 can control the communication interface 102 so that words which are similar to the error word from the text recognizing server are received. If the communication interface 102 receives similar words from the text recognizing server, the controller 110 controls the screen 190 so that similar words are displayed, and the user input for selecting any one of the similar words is received from the user.

According to the embodiment, the text recognizing server may store a candidate word group which is a set of the similar words corresponding to each word, as a result of voice recognition. For example, the text recognizing server may store words ‘homiday’, ‘holidaz’, and the like which are included in a candidate word group as a result of voice recognition of a word ‘holiday’. The electronic apparatus 100 according to the present embodiment receives the candidate word group from the text recognizing server, and can display the editing window in which the similar words included in the candidate word group are presented in a list form. For example, if it is assumed that the error word is the word ‘holiday’, the electronic apparatus 100 can receive the words ‘homiday’, ‘holidaz’, and the like which are included in the candidate word group corresponding to the word ‘holiday’ from the text recognizing server, and display the words on the editing window. The user may edit the error word by selecting any one of the similar words presented in a list form on the editing window. According to the embodiment, if the candidate word group corresponding to the error word is not stored in the text recognizing server, the electronic apparatus 100 may directly receive an input of a word to be substituted for the error word from the user.

According to the embodiment, the user can directly edit the error word in the error area 602 of an editing window 650. For example, the user may delete “e” and add “i” in the word “will” displayed in the editing window 650 by using the keypad 620.

In the present embodiment, it has been described that the editing window 650 is displayed and the text data is edited by a user input through the keypad 620. However, according to another embodiment, the text data may be edited by a writing input using a finger of the user or a stylus pen, in addition to the keypad 620. That is, the controller 110 can receive the writing input written as “will” from the user, as the user input for editing the text data. For example, the controller 110 can display the writing input window (not shown) for receiving the writing input from the user through the screen 190. The controller 110 can receive the writing input which is input through the writing input window, and edit “well” to “will” as illustrated in FIG. 6.

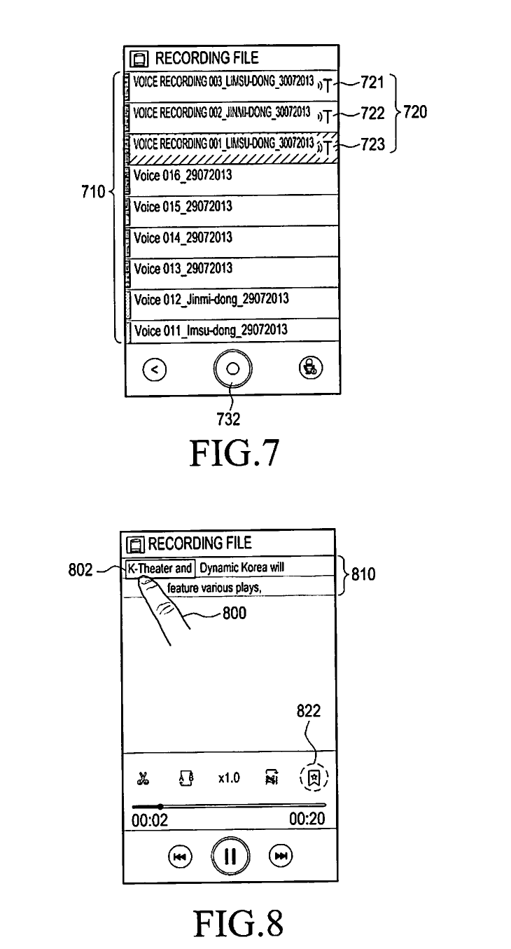

FIG. 7 is a diagram illustrating an example in which the voice data stored in the electronic apparatus illustrated in FIG. 1 is presented in a list. In FIG. 7, it is assumed that the electronic apparatus 100 stores a plurality items of voice data in the memory 108.

A list 710 including the plurality items of voice data is displayed in the execution screen of FIG. 7. The list 710 may include a file name or a title of the voice data converted by recording the voice input from the user. With reference to FIG. 7, the list 710 includes voice files with the titles of “Voice Recording 003_Imsu-dong_{—}30072013”, “Voice Recording 002_Jinmi-dong_{—}30072013”, “Voice Recording 001_Imsu-dong_{—}30072013”, “Voice 016_{—}29072013”, “Voice 015_{—}29072013”, “Voice 014_{—}29072013”, “Voice 013_{—}29072013”, “Voice 012_Jinmi-dong_{—}29072013”, “Voice 011_Imsu-dong_{—}29072013”, and the like.

When displaying the list 710 on the screen 190, the controller 110 displays the voice files included in the list 710 so that voice files 720 including text data are differentiated from voice files that do not include text data, as illustrated in FIG. 7. With reference to FIG. 7, T-shaped identifiers 721, 722, and 723 are displayed on the right of the files “Voice Recording 003_Imsu-dong_{—}30072013”, “Voice Recording 002_Jinmi-dong_{—}30072013”, and “Voice Recording 001_Imsu-dong_{—}30072013”. The electronic apparatus 100 according to the present embodiment displays the identifiers 721, 722, and 723 to be included in the list 710 so that the user can intuitively know whether text data is included or not in the corresponding voice file when looking at the list 710.

Further, the controller 110 can control the electronic apparatus 100 so that a user input for selecting any one file included in the list 710 is selected and a voice file corresponding to the corresponding user input is reproduced. FIG. 7 illustrates a state in which the user selects the voice file having the title of “Voice Recording 001_Imsu-dong_{—}30072013”. If a recording button 732 is selected by the user, the file “Voice Recording 001_Imsu-dong_{—}30072013” is reproduced. Further, since the voice file “Voice Recording 001_Imsu-dong_{—}30072013” includes text data, the text data synchronized with the voice data is displayed on the screen 190 while the voice data of the file “Voice Recording 001_Imsu-dong_{—}30072013” is generated.

FIG. 8 is a diagram illustrating an example of adding a bookmark to the text data synchronized with the voice data of the electronic apparatus illustrated in FIG. 1. FIG. 8 is an execution screen for adding the bookmark to the text data.

With reference to FIG. 8, a user 800 selects a part of “K-Theater and” in a text data 810 including characters of “K-Theater and Dynamic Korea will feature various plays”, as a bookmark area 802. As described above, the user can input a user input for selecting at least a part of the text data 810 displayed on the screen 190 as the bookmark area 802 to the electronic apparatus 100. According to the present embodiment, the user 800 first inputs the user input for selecting the bookmark area 802 to the electronic apparatus 100, and then inputs the user input for selecting a bookmark button 822 to the electronic apparatus 100 to set a specific part of the text data 810 as a bookmark.

According to the embodiment, the controller 110 determines the number of words stored in the memory 108 in advance among words included in the bookmark area 802, as a title of the bookmark. For example, the words included in the bookmark area 802 of FIG. 8 are “K-Theater and”. The controller 110 can determine “K-Theater” to be the title of the bookmark. According to another embodiment, the word positioned at the foremost may be determined to be the title of the bookmark.

If the bookmark is set as described above, the screen 190 can separately display the bookmark area 802 when displaying the text data including the bookmark under the control of the controller 110. Although not illustrated, since FIG. 8 is a diagram illustrating the execution screen for setting the bookmark area 802, when the text data 810 is displayed on the screen 190 after the bookmark area 802 is set, a separate identifier for indicating that the area is the bookmark area 802 can be displayed together with the text data 810.

According to the embodiment, while the voice data is reproduced through the electronic apparatus 100, the user input for adding a bookmark to the voice data may be input from the user. If the user input for adding the bookmark to the voice data is input as described above, the controller 110 sets a section including the voice data corresponding to a time point when the bookmark is added, as a bookmark section. Further, the controller 110 extracts at least a part of the text data corresponding to the voice data included in the bookmark section and sets the part of the text data as a bookmark title. An operation of adding the bookmark to the voice data that is being reproduced in the electronic apparatus 100 according to the present embodiment as described above can be performed while the voice file is generated. Further, the voice data can be reproduced while the electronic apparatus 100 receives the text data synchronized with the voice data from the text recognizing server and displays the text data on the screen 190 in real time. Therefore, the operation of adding the bookmark to the voice data that is being reproduced can be operated while the text data is received from the text recognizing server.

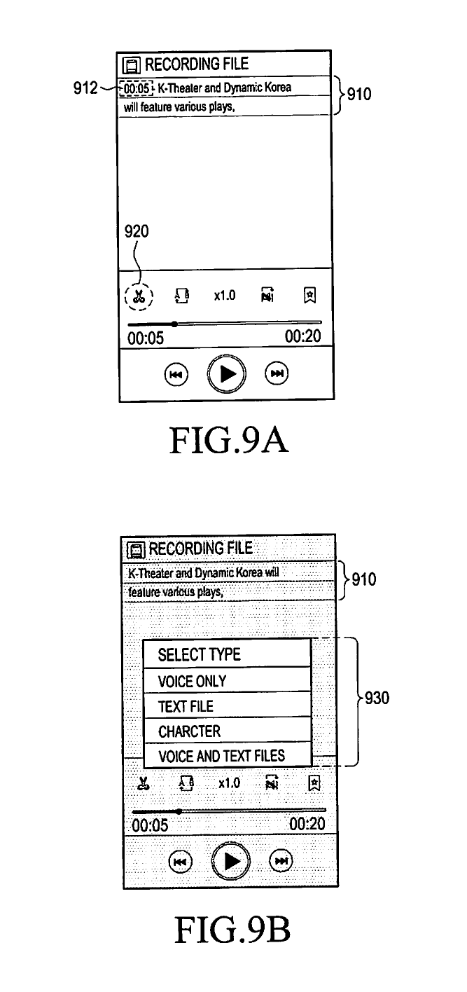

FIGS. 9A and 9B are diagrams illustrating an example of extracting a part of the voice data or the text data of the electronic apparatus illustrated in FIG. 1. FIGS. 9A and 9B illustrate execution screens for extracting the text data from the voice file.

With reference to FIG. 9A, the text data included in the voice file is displayed on the execution screen. The user inputs the user input for selecting a part to be extracted (hereinafter, an extraction area) from the execution screen displayed through the screen 190. Further, the user can extract at least a part of the voice file, voice data, or the text data, by inputting the user input by selecting an extracting button 920 in a state in which the extraction area is selected. At this point, the controller 110 controls the screen 190 so that the extraction area corresponds to which part of the voice file is displayed.

In FIG. 9A, it is assumed that the user desires to extract a part of the text data corresponding to “K-Theater and Dynamic Korea will feature various plays,” in the voice file that is being reproduced. That is, the part corresponding to “K-Theater and Dynamic Korea will feature various plays” becomes an extraction area 910. The screen 190 displays a running time 912 in the extraction area 910, for example, at the start of the extraction area 910 such as the head of the extraction area 910, in order to indicate which part of the voice file the extraction area 910 corresponds to, under the control of the controller 110. The voice file that is being reproduced in FIGS. 9A and 9B has a running time of 00:20 seconds in total. The controller 110 extracts the voice data, the text data, or the voice file in which the voice data and the text data are combined, which are output from the point of 00:05 through the screen 190 or the speaker 112 of the electronic apparatus 100, as the extraction area 910 selected by the user from the voice file.

With reference to FIG. 9B, the controller 110 receives the user input for processing the extraction area 910. According to the embodiment, the controller 110 displays an extracting menu 930 as illustrated in FIG. 9B if the extracting button 920 is input by the user in FIG. 9A. The user can determine a method of processing the extraction area 910 by inputting the user input for selecting any one of operations of the extracting menu 930 to the electronic apparatus 100.

The extracting menu 930 of FIG. 9B includes “Voice Only”, “Text File”, “Character”, and “Voice and Text Files”. “Voice Only” refers to an operation of extracting voice data corresponding to the extraction area 910 and storing the extracted voice data as a separate voice data. “Text File” refers to an operation of converting the text data corresponding to the extraction area 910 into a text file and storing the text file. “Character” refers to an operation of extracting the text data corresponding to the extraction area 910 and storing the extracted text data. “Voice and Text Files” refers to an operation of extracting both of the voice data and the text data corresponding to the extraction area 910 and storing the extracted voice and text data as a separate voice file. For example, if “Text Files” in the extracting menu 930 is selected by the user, the controller 110 converts the extraction area 910, that is, “K-Theater and Dynamic Korea will feature various plays” into a text file, and stores the text file in the memory 108.

As described above, the present invention provides a method of modifying text data corresponding to voice data, which can enhance the accuracy of the text data by correcting errors of the characters that are generated in the course of converting a voice into a text or after the conversion of the voice into the text, and an electronic apparatus for the same.

It should be understood that a method of modifying the text data corresponding to the voice data according to the embodiment of the present invention or a method of generating the text data corresponding to the voice data can be realized by hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. The method of modifying the text data corresponding to the voice data or the method of generating the text data corresponding to the voice data according to the embodiment of the present invention can be embodied by a computer or a portable terminal including a controller and a memory, and the memory is an example of a machine-readable storage medium which is appropriate for storing a program or programs including instructions for realizing the embodiments of the present invention. Accordingly, the present invention includes a program for a code implementing the apparatus and method described in the appended claims of this specification and a machine (a computer or the like)-readable storage medium for storing the program. Moreover, such a program as described above can be electronically transferred through an arbitrary medium such as a communication signal transferred through cable or wireless connection, and the present invention properly includes things equivalent to that.

Further, the electronic device may receive the program from a program providing device connected to the electronic device by wire or wirelessly and may store the received program. The program providing device may include a memory that stores a program including instructions for performing a method of modifying predetermined text data by the electronic apparatus or a method of generating the text data, and information required for the method of modifying the text data or the method of generating the text data, and the like, a communication unit that performs a wired or wireless communication with the electronic apparatus, and a controller that transmits a corresponding program to the electronic apparatus automatically or according to the request of the electronic apparatus.

In addition to the above, various embodiments or modifications of the present invention are possible, and therefore the scope of the present invention is not determined by the embodiments described above, but determined by the appended claims and equivalents thereof.

What is claimed is:

1. A method of modifying text data corresponding to voice data, comprising:
reproducing voice data included in a voice file;
displaying text data included in the voice file;
determining whether a user input for editing the text data is input; and
editing the text data in response to the user input, if the user input for editing the text data is input.

2. The method according to claim 1, wherein displaying the text data comprises:
displaying text data corresponding to a part of the voice data that is being reproduced in such a manner that is differentiated from a part that is not being reproduced.

3. The method according to claim 1, wherein determining whether the user input for editing the text data is input comprises:
determining that the user input for editing the text data is input if a user input for determining an error area of the text data displayed on the screen has been input.

4. The method according to claim 3, wherein editing the text data in response to the user input comprises:
determining an error word included in the error area;
displaying the error word and substitution words having similarity values greater than or equal to a pre-stored reference value;
receiving a user input for selecting any one of the substitution words from a user; and
replacing the error word with the substitution word selected by the user.

5. The method according to claim 3, wherein editing the text data in response to the user input comprises:
determining an error word included in the error area;
requesting a candidate word group corresponding to the error word from a text recognizing server;
receiving the candidate word group from the text recognizing server if the candidate word group exists in the text recognizing server;
displaying the error word and substitution words included in the candidate word group;
receiving a user input for selecting any one of the substitution words from a user; and
replacing the error word with the substitution word selected by the user.

6. The method according to claim 3, wherein editing the text data in response to the user input comprises:
determining an error word included in the error area;
requesting and receiving a candidate word group corresponding to the error word from a text recognizing server;
selecting any one of substitution words having similarity values greater than or equal to a pre-stored reference value or substitution words included in the candidate word group corresponding to the error word; and
replacing the error word with the selected substitution word.

7. The method according to claim 6, wherein editing the text data in response to the user input further comprises:
displaying the substitution words having the similarity values greater than or equal to the reference value or the substitution words included in the candidate word group.

8. The method according to claim 3, wherein editing the text data in response to the user input includes:
determining an error word included in the error area;
receiving a substitution word from a user; and
replacing the error word with the substitution word.

9. The method according to claim 1, further comprising:
receiving a user input for determining an extraction area in the text data displayed on a screen; and
storing text data only included in the extraction area.

10. The method according to claim 1, further comprising:
receiving a user input for determining an extraction area in the text data displayed on a screen; and
extracting voice data corresponding to text data included in the extraction area; and
storing the voice data.

11. The method according to claim 1, further comprising:
receiving a user input for determining an extraction area in the text data displayed on a screen; and
extracting and storing text data included in the extraction area and voice data corresponding to the text data included in the extraction area.

12. The method according to claim 1, after reproducing the voice data included in the voice file, further comprising:
receiving a user input for adding a bookmark to the voice data;
setting a section including the voice data corresponding to a time point when the bookmark is added, as a bookmark section;
extracting at least one part of text data corresponding to the voice data included in the bookmark section; and
setting the at least one part of the text data as a bookmark title.

13. A method of generating text data corresponding to voice data, comprising:
generating voice data by receiving a voice from a user;
generating text data synchronized with the voice data; and
generating a voice file by combining the voice data and the text data.

14. The method according to claim 13, further comprising:
displaying the text data in real time.

15. The method according to claim 14, further comprising:
determining whether a user input for editing the text data is input; and
editing the text data in response to the user input if the user input for editing the text data is input.

16. The method according to claim 15, wherein editing the text data in response to the user input comprises:
determining an error word included in an error area;
displaying the error word and substitution words having similarity values greater than or equal to a pre-stored reference value;
receiving a user input for selecting any one of the substitution words from the user; and
replacing the error word with the substitution word selected by the user.

17. The method according to claim 15, wherein editing the text data in response to the user input comprises:
determining an error word included in an error area;
requesting a candidate word group corresponding to the error word from a text recognizing server;
receiving the candidate word group from the text recognizing server if the candidate word group exists in the text recognizing server;
displaying the error word and substitution words included in the candidate word group;
receiving a user input for selecting any one of the substitution words from a user; and
replacing the error word with the substitution word selected by the user.

18. The method according to claim 15, wherein editing the text data in response to the user input comprises:
determining an error word included in an error area;
requesting and receiving a candidate word group corresponding to the error word from a text recognizing server;
selecting any one of substitution words having similarity values greater than or equal to a reference pre-stored value or substitution words included in the candidate word group corresponding to the error word; and
modifying the error word into the selected substitution word.

19. The method according to claim 18, wherein editing the text data in response to the user input further comprises:
displaying the substitution words having the similarity values greater than or equal to the reference value or the substitution words included in the candidate word group.

20. The method according to claim 15, wherein editing the text data in response to the user input comprises:
determining an error word included in an error area;
receiving a substitution word from a user; and
replacing the error word with the substitution word.

21. The method according to claim 13, wherein generating the text data synchronized with the voice data includes:
transmitting the voice data to a text recognizing server; and
receiving text data synchronized with the voice data from the text recognizing server.

22. The method according to claim 21, further comprising:
displaying at least one word included in the text data according to accuracy of the text data in a different color.

23. The method according to claim 13, further comprising:
receiving a user input for adding a bookmark to the voice data;
setting a section of the voice data corresponding to a time point when the bookmark is added, as a bookmark section;
extracting at least one part of text data corresponding to the bookmark section; and
setting the at least one part of the data as a bookmark title.

24. An electronic apparatus for modifying text data corresponding to voice data, comprising:
a screen configured to display text data synchronized with voice data; and
a controller configured to:
control the screen to reproduce the voice data and display the text data,
determine whether a user input for editing the text data is input, and
edit the text data in response to the user input if the user input for editing the text data is input.

25. The electronic apparatus according to claim 24, wherein the controller is configured to control the screen to display text data corresponding to a part of the voice data that is being reproduced in such a manner that is differentiated from a part that is not being reproduced.

26. The electronic apparatus according to claim 24, wherein the controller is configured to determine that the user input for editing the text data is input if a user input for determining an error area of the text data displayed on the screen has been input.

27. The electronic apparatus according to claim 26, wherein the controller is configured to determine an error word included in the error area, controls the screen to display the error word and substitution words having similarity values greater than or equal to a pre-stored reference value, control the screen to receive a user input for selecting any one of the substitution words from the user, and replace the error word with the substitution word selected by the user.

28. The electronic apparatus according to claim 26, further comprising:
a communication interface configured to request a candidate word group corresponding to an error word included in the error area from a text recognizing server,
wherein the controller is configured to determine the error word, control the communication interface to request the candidate word group corresponding to the error word from the text recognizing server, control the communication interface to receive the candidate word group from the text recognizing server if the candidate word group exists in the text recognizing server, control the screen to display the error word and substitution words included in the candidate word group, and replace the error word with the substitution word selected by the user if the user input for selecting any one of the substitution words is input from the user.

29. The electronic apparatus according to claim 28, wherein the controller is configured to select any one of substitution words having similarity values greater than or equal to a pre-stored reference value or substitution words included in the candidate word group corresponding to the error word, and replace the error word with the selected substitution word.

30. The electronic apparatus according to claim 29, wherein the controller is configured to control the screen to display the substitution words having the similarity values greater than or equal to the reference value or the substitution words included in the candidate word group.

31. The electronic apparatus according to claim 26, wherein the controller is configured to determine an error word included in the error area, receive a substitution word from the user through the screen, and replace the error word with the substitution word.

32. The electronic apparatus according to claim 24, wherein the screen is configured to receive a user input for determining an extraction area of the text data, and
the controller is configured to store only text data included in the extraction area.

33. The electronic apparatus according to claim 24,
wherein the screen is configured to receive a user input for determining an extraction area of the text data; and
the controller is configured to extract and store voice data corresponding to text data included in the extraction area.

34. The electronic apparatus according to claim 24,
wherein the screen is configured to receive a user input for determining an extraction area of the text data, and
the controller is configured to extract and store text data included in the extraction area and voice data corresponding to the text data included in the extraction area.

35. The electronic apparatus according to claim 24, wherein the controller is configured to set a section including the voice data corresponding to a time point when a bookmark is added if the user input for adding the bookmark to the voice data is input, as a bookmark section, extract at least one part of text data corresponding to voice data included in the bookmark section, and set the at least one part of the text data, as a bookmark title.

36. An electronic apparatus for generating text data corresponding to voice data, comprising:
a controller configured to:
generate voice data upon receiving a voice from a user,
generate text data synchronized with the voice data, and
generate a voice file by combining the voice data and the text data; and
a screen configured to display the text data in real time.

37. The electronic apparatus according to claim 36, wherein the controller is configured to determine whether a user input for editing the text data is input, and edit the text data in response to the user input if the user input for editing the text data has been input.

38. The electronic apparatus according to claim 36, wherein the controller is configured to determine an error word included in an error area, control the screen to display the error word and substitution words having similarity values greater than or equal to a pre-stored reference value, and replace the error word with the substitution word selected by the user, if a user input for selecting any one of the substitution words from the user is input.

39. The electronic apparatus according to claim 36, further comprising:
a communication interface configured to request a candidate word group corresponding to an error word from a text recognizing server, if the error word included in an error area is determined by the controller, and
wherein the controller is configured to control the communication interface to receive the candidate word group from the text recognizing server, if the candidate word group exists in the text recognizing server, control the screen to display the error word and substitution words included in the candidate word group, and replace the error word with the substitution word selected by the user if a user input for selecting any one of the substitution words is input from the user.

40. The electronic apparatus according to claim 36, further comprising:
a communication interface configured to request a candidate word group corresponding to an error word from a text recognizing server if the error word included in an error area is determined by the controller, and
wherein the controller is configured to select any one of substitution words having similarity values greater than or equal to a pre-stored reference value or substitution words included in the candidate word group corresponding to the error word, and replace the error word with the selected substitution word.

41. The electronic apparatus according to claim 40, wherein the controller is configured to control the screen to display the substitution words having the similarity values greater than or equal to the reference value or the substitution words included in the candidate word group.

42. The electronic apparatus according to claim 36, wherein the controller is configured to determine an error word included in an error area, and replace the error word with a substitution word if the substitution word is input from the user.

43. The electronic apparatus according to claim 36, further comprising:
a communication interface configured to:
transmit the voice data to a text recognizing server, and
receive text data synchronized with the voice data from the text recognizing server.

44. The electronic apparatus according to claim 36, wherein the controller is configured to control the screen to display at least one word included in the text data in different colors, according to accuracy of the text data.

45. The electronic apparatus according to claim 36, wherein the controller is configured to set a section of the voice data corresponding to a time point when a bookmark is added if the user input for adding the bookmark to the voice data is input, as a bookmark section, extract at least one part of text data corresponding to the bookmark section, and set the at least one part of the text data, as a bookmark title.
